(19) United States
(12) Patent Application Publication
(10) Pub. No.: US 2007/0180377 A1
(43) Pub. Date: Aug. 2, 2007

(54) Self-translating template

(75) Inventors: Arye Gittelman, Mercer Island, WA (US); Florian W. H. Voss, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/342,909

(22) Filed: Jan. 30, 2006

(51) Int. Cl. G06F 9/00

(52) U.S. Cl. 715/703; 715/764; 715/963

(57) ABSTRACT

Displaying a calendar. A method may be practiced, for example, in a computing environment. The method includes obtaining a culture neutral calendar layout template as one or more data structures on a computer readable medium. Culture context information is referenced. Culture information stored as one or more data structures on a computer readable medium is selected based on the culture context. The culture neutral calendar layout template is merged with the culture information to create a culture specific calendar view.

### BACKGROUND

### Background and Relevant Art

Computers and computing systems have affected nearly every aspect of modem living. Computers are generally involved in work, recreation, healthcare, transportation, entertainment, household management, etc.

Computers may further include functionality for allowing design tools to be implemented on the computers. For example, a computer can run a software application that allows the user to design various graphic arts projects. In one example, software applications may be able to be used to design calendars. Using the software applications, a user can design the type of calendar such as a daily calendar, a weekly calendar, a monthly calendar, or a yearly calendar. Additionally, the user may add graphical features such as various images and the like.

Computers of additionally include functionality for allowing scheduling activities to be performed. For example, a user can input scheduling activities into a scheduling program. While these schedules can be printed, the range of calendar styles and formats and culture options is quite limited.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method of displaying a calendar. The method may be practiced, for example, in a computing environment. The method includes obtaining a culture neutral calendar layout template from among a selection of calendar layout templates as one or more data structures on a computer readable medium. Culture context information is referenced. Culture information stored as one or more data structures on a computer readable medium is selected based on the culture context. The culture neutral calendar layout template is merged with the culture information to create a culture specific calendar view.

Another embodiment includes one or more computer readable media. The one or more computer readable media include a first data structure that includes information defining a culture neutral calendar layout. The culture neutral calendar layout is selected from a number of calendar layout templates. The one or more computer readable media further include a second data structure including culture information. A third data structure, including culture context information corresponding to the culture information is included in the one or more computer readable media. Further, the one or more computer readable media include computer executable instructions configured to merge the culture neutral calendar layout template with the culture information based on a reference to the culture context information to create a culture specific calendar view.

Yet another embodiment includes a method of presenting calendar views including culture information merged with a culture neutral calendar template. The method may be practiced for example, in a computer system having a graphical user interface including a display and a user interface selection device. The method includes displaying a selection of views representing selectable culture neutral calendar layout templates. User input is received selecting one of the selectable culture neutral calendar layout templates. Input is received defining a culture context. Culture information is received defining culture specific details. A calendar view is displayed in a culture specific fashion defined by culture information corresponding to the culture context merged with the one of the selectable culture neutral calendar layout templates selected by the received user input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates information that may be merged to create a calendar view;

FIG. 2 illustrates various time units that may be displayed in a calendar view;

FIG. 3 illustrates a calendar view;

FIG. 4 illustrates a graphical user interface that may be used to select culture neutral calendar layout templates;

FIG. 5 illustrates a method of displaying a calendar; and

FIG. 6 illustrates a method of presenting calendar views.

### DETAILED DESCRIPTION

Embodiments herein may comprise a special purpose or general-purpose computer including various computer hardware, as discussed in greater detail below.

One example illustrated herein is directed to methods and systems for displaying a calendar in a culturally specific fashion. For example, it may be desirable to display a calendar in an appropriate language and with appropriately delineated time units for a particular culture. Additionally, it may be desirable to include functionality for displaying calendars in various culture contexts so as to be able to allow for distribution of calendar layout templates to a wide variety of culturally diverse users.

A culture neutral calendar template may be provided. The culture neutral calendar template may include information that defines particular calendar features. For example, the culturally neutral calendar template may include information defining time units such as a day time unit, a week time unit, a month time unit, a year time unit, and/or a multi-year time unit. The culture neutral calendar template may further include information defining and/or specifying general layout information, borders, fonts, shading, colors, and the like. In one embodiment, the culture neutral calendar template may be in an extensible format such as an XML format such that a wide variety of culture neutral calendar templates can be created.

Culture information may be merged with the culture neutral calendar template so as to create a culture specific calendar view. The culture information may define information for a specific culture. For example culture information may exist for Americanized English cultures. A culture context may be applied to the culture neutral calendar template so as to select appropriate cultural information for creating the calendar view. Notably, the culture neutral calendar template may also be merged with event information so as to create a personalized schedule that includes personalized events and activities for an individual in addition to presenting a calendar view with a culture specific context appropriate for the individualized user.

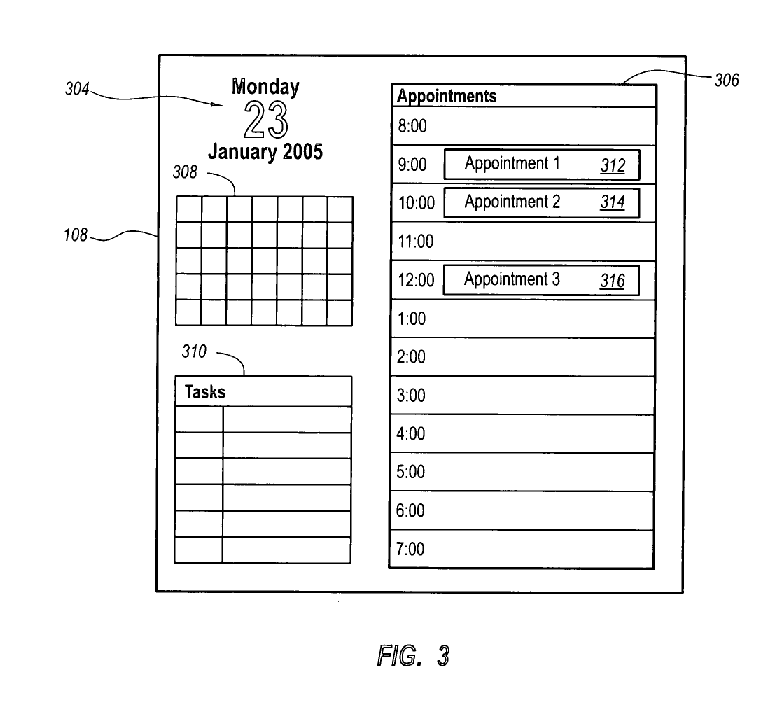

Referring now to FIG. 1, a detailed example of one embodiment is illustrated. FIG. 1 illustrates a culture neutral calendar template 102. As described previously, the culture neutral calendar template 102 may be an XML file or other appropriate data structure which includes information defining a calendar layout. The calendar layout may define the type of time unit to be displayed such as for example a day time unit, a week time unit, a month's time unit, a year time unit, and/or a multi-year time unit. In addition, the culture neutral calendar template 102 may allow for displaying multiple time units together. For example, the culture neutral calendar template 102 may define a single primary time unit such as a week time unit which includes calendar controls that may be used to define day time units within the week time unit. Further still, in yet another example, the culture neutral calendar template 102 may define a primary month time unit that includes calendar controls that may be used to define week time units and day time units within the month time unit. Additionally, the culture neutral calendar template 102 may define disjointed time units, such as when a day time unit is displayed with a disjointed month time unit. Such an example is illustrated later herein at FIG. 3. It should be noted that in some embodiments due to the extensible nature of the culture neutral calendar template 102 the culture neutral calendar template 102 is not constrained by traditional calendar views. For example, a month time unit may be illustrated with two columns instead of the traditional seven columns used to display a month calendar.

FIG. 1 further illustrates that culture information 104 is combined with the culture neutral calendar template 102 to create a calendar view 108. As shown in FIG. 1, a culture context 106 is applied to the culture neutral calendar template 102 to define the culture information 104 that is selected for merging with the culture neutral calendar template 102 to create the calendar view 108.

The culture information 104 may define various features to enable the calendar view 108 to be displayed as a culturally specific calendar view. For example, the culture information 104 may include textual strings that may be used to replace string references in the culture neutral calendar template 102. In one embodiment, the culture information 104 may include a closed set of all expected content within a calendar view, exclusive of individual schedule information. For example, the expected content may include text such as calendar title headings, and the like. As such, the embodiment includes a sufficient amount of information for translating all expected content into an appropriate language. With regard to calendar headings, the culture information may include textual representations of commonly used labels such as appointments, tasks, budget, or other textual labels commonly found in calendar applications.

In one particular embodiment the culture information 104 maybe embodied as one or more dynamic link libraries (dlls). The one or more dlls may include the closed set of translated items for a number of different languages where the information in the dlls can be applied to the culture neutral calendar template 102 based on the culture context 106.

The culture information 104 may further specify text orientations. Illustratively, some cultures utilize textual representations where text is read from right to left. Other cultures use textual representations where text is read from left to right. Further still, some cultures use textual representations where text is read from top to bottom and/or bottom to top. Thus, the culture information 104 can specify that text displayed in the calendar view 108 should be oriented in an orientation appropriate for the culture context 106 applied to the culture neutral calendar template 102. Orientation may also refer to the orientation of time unit elements. For example, the orientation of a particular culture may define how days are laid out in a month view calendar.

The culture information 104 may further include information specifying display or paper features. Illustratively, different cultures often use different size paper for ordinary day to day tasks. For example, and the United States 8.5×11 paper size it is common. In many European countries however, A4 paper is often used. A4 paper typically measures about 8.27×11.69 inches thus, culture information for United States cultures may specify a paper size of 8.5×11, whereas other paper sizes may be specified for other cultures in the culture information 104.

Additionally, the culture context 106 may be applied to requests for information to obtain the appropriate information in an appropriate language. For example, the culture neutral calendar template 102 may specify the name of a week day be printed in the calendar view 108. The culture neutral calendar template 102 may specify a request for a day that includes a day request and the specification of a language. For example, when using .Net classes available from Microsoft Corporation, a request for a day may include the markup “dd” plus a reference to a particular language. Some embodiments may further allow for the addition of other characters when appropriate for a particular culture context 106. For example, a Japanese context would result in a day name being retrieved using a .Net request “dd” based on the Japanese language and the day name being combined with a traditional Japanese character commonly used in the representation of the day. The additional characters may be included for example in the culture information 104.

As illustrated in FIG. 1, event information 110 may be further merged with the culture neutral calendar template 102 and culture information 104 in the creation of the calendar view 108. This allows for the creation of a an individualized schedule that can be provided for a user such that the calendar view 108 includes specific events, or other activities of interest to the particular user. For example, the event information 110 may include a selection of holidays or other important dates particular to a particular country, region, locale etc. Additionally, the calendar view 108 becomes highly personalized by presenting such event information 110 to the user based on the user's particular culture context 106.

Turning now to the culture context 106, various alternative embodiments from which the culture context 106 can be derived will now be illustrated. In one example, the culture context 106 may include information derived from the system settings of a personal computer being used by a particular user. Illustratively, operating systems often provide a user with a graphical user interface that allows the user to select a cultural context. Users can select time zones, countries, languages, dialects of languages, and other culturally specific information. These user selections may be stored in an appropriate location such as a data structure included as part of a registry. This data structure can then be referenced as the culture context 106 which can then be applied to the culture neutral calendar template to create a culture specific calendar view 108.

In another embodiment, the culture context 106 may be specified explicitly in a user defined data file. As such, a reference can be applied to the culture neutral calendar template 102 to reference the data file so as to be able to gather the culture context 106.

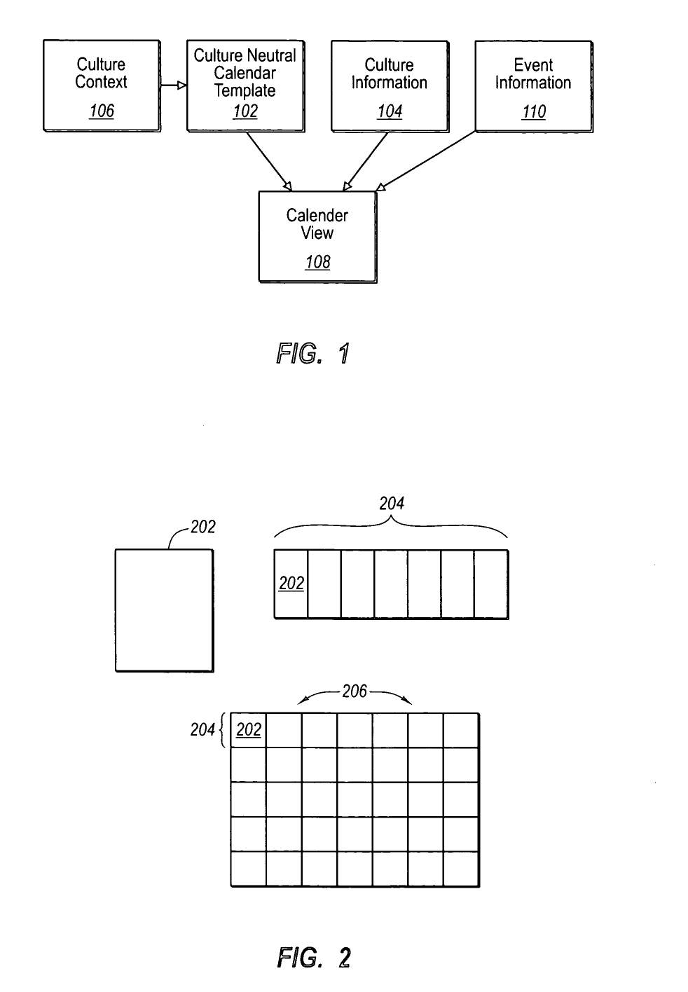

Referring now to FIG. 2, various time units are illustrated. For example, FIG. 2 illustrates a day time unit 202, a week time unit 204, and a month time the unit 206. And shown, the week time unit 204 in this example includes day time units 202. The month time the unit 206 includes day time the units 202 and week time units 204. As discussed previously, embodiments herein are not constrained to the traditional seven day a week or five week month as illustrated in the FIG. 2. Further, embodiments may not be constrained by other time unit definitions. In particular, when a calendar view is displayed within a culture context, one cultures display of time units may not correlate directly with another cultures context of time units. For example, while many cultures use a standard twelve month calendar, other cultures such as some Hebrew cultures use a thirteen month calendar for certain years. Thus, and referring once again to FIG. 1, the culture information 104 may include layout information for the time units. For example, the culture information may specify the number of time units within a particular time unit. Specifically, in the Hebrew calendar example described above, the culture information 104 may define 13 months for some year time units. Additionally, while a day time unit 202, a week time unit 204 and a month time unit 206 have been illustrated in this example, it should be understood that other time units such as year time units and multi year time units may also be implemented. Additionally, in some embodiments, time units may be defined a primary time units that include controls for nested time units. For example, a month time unit may include calendar controls for the nested week time units and day time units.

Referring now to FIG. 3, a calendar view 108 is illustrated. In the particular calendar view 108 illustrated in FIG. 3, the calendar view includes a day reference 304 a day view 306 a month view 308 and a tasks block 310. In this example, the day view 306 is a slot view which includes a number of discrete time slots where appointments 312, 314, and 316 can be applied. In an alternative embodiment not illustrated here, a list view may be implemented were a list view lists activities or appointments or times of interest in a list with pertinent information such as time and location of the particular activity, appointment, or time of interest. Other views may also be implemented such as grid views, appointment views, free/busy views, and the like.

As described previously, the culture information 104 may be useful for instantiating specific instances within a culture context 106. For example, the culture information 104 may include information dictating how the day reference 304 is displayed. For example, the culture information 104 may include specific textual strings including language translation information for the text used, in conjunction with other retrieved day information, to render the day reference 304 when appropriate. For example, as described above, within the Japanese culture, it may be desirable to include additional characters when rendering a day reference 304. Additionally, the culture information 104 may define how the day reference 304 is laid out. For example, if it is appropriate within a particular culture context 106 to order the numerical day reference before the name of the day such information may be included in the culture information 104. Additionally, the culture information 104 can include information that specifies an orientation of how columns are laid out. For example, if calendars are typically read in a culture from right to left, appropriate changes can be made to the calendar view 108 to accommodate for the particular cultural context 106. This layout information can be defined in the culture information 104.

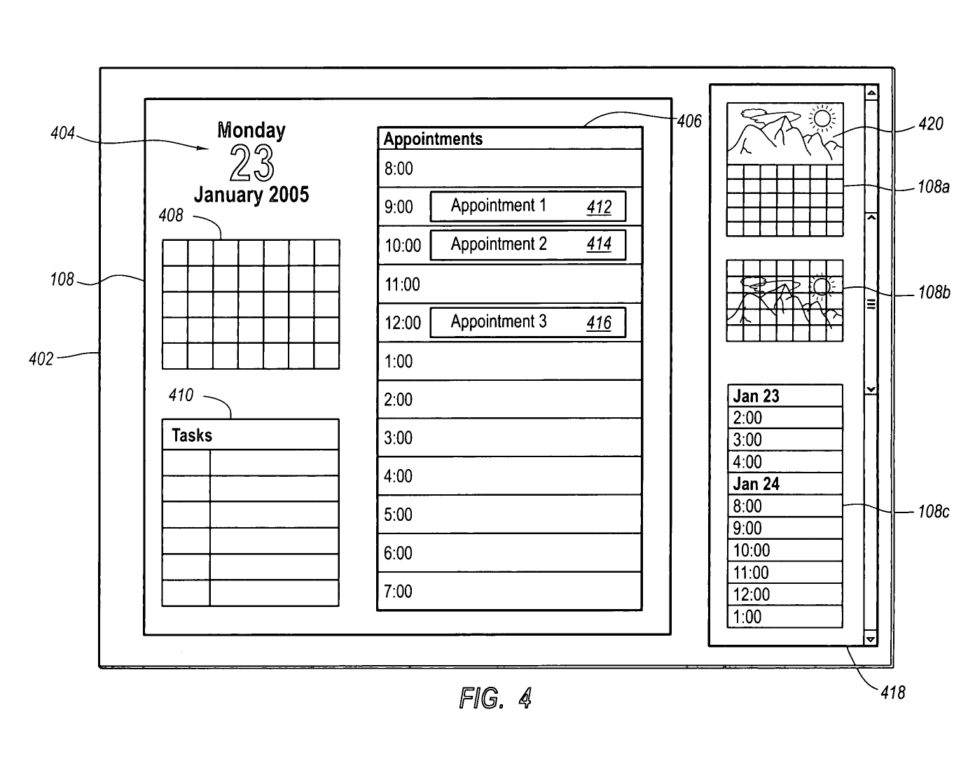

One embodiment described herein includes a graphical user interface that facilitates a user selecting a culture neutral calendar layout template 102 from a selection of predefined calendar layout templates. For example, and referring to FIG. 4, a graphical user interface 402 is illustrated. The graphical user interface 402 illustrates a calendar view 108 where a selected template has been merged with appropriate schedule information and culture information to form the calendar view 108. The particular calendar view 108 shown in FIG. 4 includes a date indicator 404 a day time unit 406 a month time unit 408 and a tasks block 410. The date indicator 404 lists the particular date instance for which the calendar view 108 is being created. The month time unit 408 is a standard five week/seven day month view. The day time unit 406 in this particular example is a weekday appointment view that includes hourly time slots. As such, the day time unit 406 is instantiated as a slot view. In the example shown, a first appointment 412 is illustrated in a 9:00 slot, a second appointment 414 is illustrated in the 10:00 slot and a third appointment 416 is illustrated in the 12:00 slot.

Illustratively, the graphical user interface 402 illustrates a number of calendar views 108a, 108b and 108c that may be selected. A user may select one of the calendar views 108a, 108b or 108c, which are instances of culture neutral calendar layout templates merged with schedule information and culture information. By selecting one of the calendar views 108a, 108b and 108c a user can select an appropriate calendar layout template 102 corresponding to the calendar view selected. When a user selects a calendar view from the calendar template selection list 418, the calendar view selected will appear as the calendar view 108 in the graphical user interface 402. This calendar view 108 in the graphical user interface 402 can then be printed or otherwise used as a graphical display of the user's selection.

The calendar layout templates used to create the calendar views 108a 108b and 108c in the calendar template selection list 418 may be created, as described above, as markup language documents. This allows third party template creators to easily create new calendar layout templates 102. These created calendar layout templates can be downloaded by a user and imported into the application implementing the graphical user interface 402 such that calendar views can be imported into the calendar template selection list 418. As such, a virtually unlimited selection of calendars can be made available to a user.

As described previously, a number of various features can be integrated into calendar templates 102. For example, as shown in FIG. 4, the calendar layout template 108 allows for a single template to include a month time unit 408 a day time unit 406 and a tasks structure 410. Various other features may also be implemented such as for example an invoice data structure, a notes structure, and the like. Additionally as shown in FIG. 4 by the calendar view 108a, calendar layout templates may include references to graphical images 420 which may be for example displayed at the top of a calendar view 108a or as a background image as shown in calendar view 108b. Additionally, those of skill and the art will understand that graphical images 420 as well as text hyperlinks and other content may be located at various other positions within a calendar view 108.

FIG. 4 further illustrates other features that may be implemented by virtue of the flexibility of the language used to create calendar layout templates. For example, calendar view 108c illustrates an interesting view where a day view includes a rolling day view. In a rolling day view, portions of two distinct dates can be displayed in a single time unit. For example, the calendar view 108c illustrates the last half of a working day labeled January 23 and the first half of the subsequent working days labeled January 24. Various other views and layouts may also be created limited only by the creativity of the calendar layout template creator. In other words, the extensibility of a language used for the calendar layout template allows for virtually unlimited configurability of calendar layout templates 102.

As described previously, the graphical user interface 402 may include user selectable elements that allow the calendar view 108 to be printed. Embodiments may therefore include functionality for facilitating enhanced printing capabilities. For example, the calendar view 108 includes information from the culture neutral calendar layout template 102 . The calendar view 108 can therefore be formatted such that when the calendar view 108 is selected to be of a particular size, the text displayed in the calendar view can be sized appropriately so as to minimize or eliminate the loss of information. Embodiments herein, however, allow for information to be resized within the calendar view 108 automatically by the application used to create the calendar view 108 so as to preserve information when the calendar view 108 is printed. This functionality may be especially useful when a calendar view 108 is formatted for a particular culture context 106. For example, as described previously, different cultures use different paper sizes for day to day printing activities. As such, there may be a use for adjusting font sizes, or calendar features such as slot sizes to accommodate changes in size and proportion of paper used to print the calendar view 108. Similar functionality may be implemented when selecting paper sizes or orientations within a culture. For example, a user may specify a portrait or landscape orientation within a given culture context. Changes in orientation may result in dynamic changes to calendar view features so as to minimize or eliminate information being lost due to insufficient space to display or print the information.

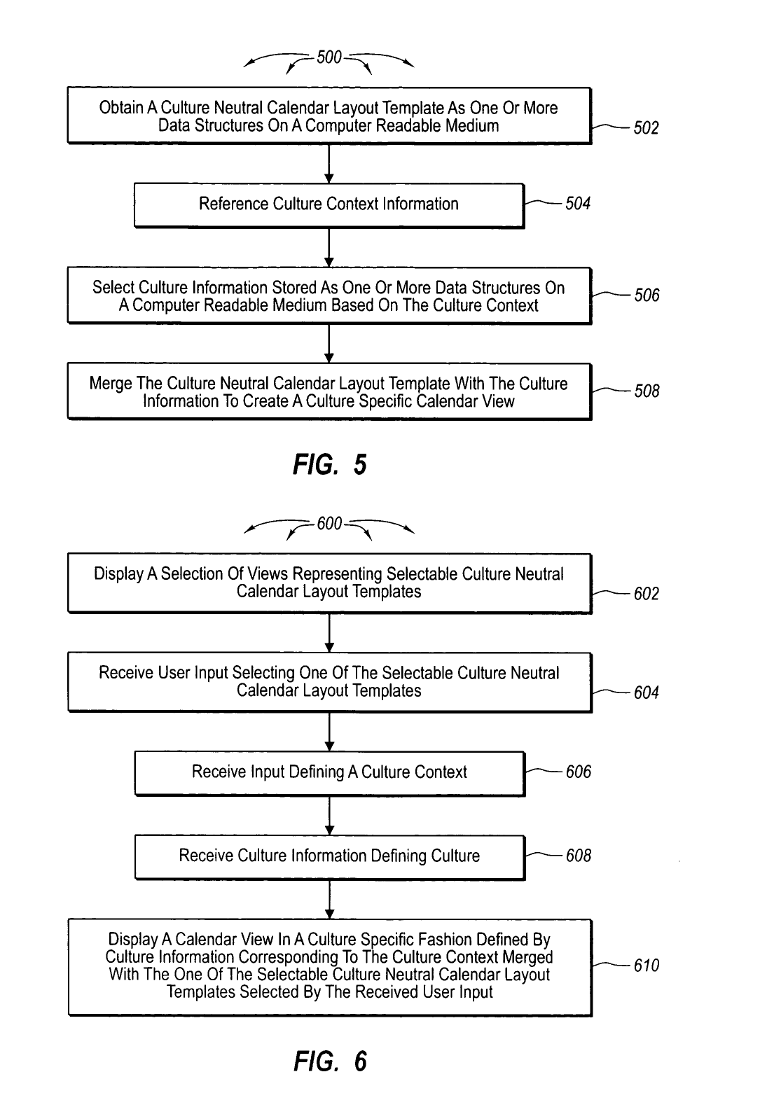

Referring now to FIG. 5, a method of displaying a calendar is illustrated. The method may be practiced, for example, in a computing environment. The method includes obtaining a culture neutral calendar layout template as one or more data structures on a computer readable medium (act 502). The culture neutral calendar layout template may be obtained from among a number of calendar layout templates. In one embodiment, obtaining a culture neutral calendar layout template may include downloading a calendar template. For example, a calendar template may be downloaded from a collection of templates available from a designer. Alternatively, obtaining a culture neutral calendar template may include creating the template from scratch. In one embodiment, the culture neutral calendar template may be a mark-up language document such as an XML document.

Referring once again to FIG. 5, the method 500 further illustrates referencing culture context information (act 504). In one embodiment referencing culture context information (act 504) may include referencing system settings of a computer system. For example, a computer system may allow a user to select culture context such as by selecting a language, time zone, country, or other selection. These user selections may be stored in a registry entry that can be referenced to determine a culture context. Based on the user selections stored in the registry, a culture specific calendar view can be rendered.

Referring once again to FIG. 5, the method 500 further illustrates selecting culture information stored as one or more data structures on a computer readable medium based on the culture context (act 506). For example, culture information may be stored in a mark-up language document or a dynamic link library (dll). The culture information may include for example information defining date patterns, text layout patterns, view sizes and so forth. Additionally, the culture information may include strings that may be used to replace variables within the culture neutral calendar template. For example, in one embodiment, the culture information may include translations for various textual strings such as calendar headings. In one embodiment, when a dll is used to embody the culture information, the culture information may contain a closed set of translations so as to be able to facilitate functionality whereby all expected textual strings in a calendar display can be displayed in the appropriate language for the particular culture context.

Referring once again to FIG. 5, the method 500 includes merging the culture neutral calendar layout template with the culture information to create a culture specific calendar view (act 508). As described previously, creating a culture specific calendar view may include replacing strings with text in a culturally specific language. For example, calendar headings be represented in a language appropriate for the culture context.

Creating a culture specific calendar view may include displaying content with a culturally specific date format. For example, certain cultures display month followed by day followed by year, i.e. mmddyyyy. Other cultures display day followed by month followed by year, i.e. ddmmyyyy. The culture information may specify the appropriate format for different culture contexts so that creating a culture specific calendar view may include displaying content with a culturally specific date format.

Creating a culture specific calendar view may include displaying content in a culturally specific orientation. For example, some cultures specify that content is read from right to left. Other cultures specify that content is read from left to right. Still other cultures have content read from top to bottom and bottom to top. Thus, culture information may specify an appropriate orientation.

Creating a culture specific calendar view may include displaying content within a view size specified for a particular culture. For example some cultures typically use 8.5×11 inch paper size for day to day printing tasks. Other cultures use other sizes such as A4 which is closer to 8.27×11.69 inches. The culture information may indicate the appropriate paper size for the culture context. This allows creating a culture specific calendar view may include displaying content within a view size specified for a particular culture. Additionally, embodiments may include functionality for changing font sizes and layouts to allow information to be displayed with minimal or no loss of information within the available view size.

The method 500 may further include merging event information with the culture neutral calendar template such that the culture specific calendar view includes a representation of scheduled events. For example, specific scheduling instances of events, holidays, and the like may be merged with the culture neutral calendar layout template. Thus, a culture specific calendar view may be displayed with specific user events applicable to the user in a culture applicable to the user.

481 Referring now to FIG. 6, a method 600 of presenting calendar views is illustrated. The method may be practiced for example in a computer system having a graphical user interface including a display and a user interface selection device. For example, the graphical user interface may be displayed on a display device such as a CRT, LCD or other appropriate display. User interface devices may include for example keyboards, mice, trackballs, touch screens, pen tablets, or any other appropriate and suitable device. The method includes displaying a selection of views representing selectable culture neutral calendar layout templates (act 602). For example, FIG. 4 illustrates a calendar template selection lists 418 that displays views that are user selectable.

The method 600 further includes receiving user input selecting one of the selectable culture neutral calendar layout templates. For example, a user may select a calendar view from the calendar template selection list 418.

The method 600 further includes receiving input defining a culture context (act 606). As described previously, the input may be derived for example from user settings in an operating system, or from any other appropriate source.

The method 600 further includes receiving culture information defining culture specific details (act 608). Such culture information may include text translations, orientation definitions, view sizes, and the like. The information may be stored in a mark-up language document, a dll or other appropriate data structure.

The method 600 further includes displaying a calendar view in a culture specific fashion defined by culture information corresponding to the culture context merged with the one of the selectable culture neutral calendar layout templates selected by the received user input (act 610). For example, as shown in FIG. 4, a user selecting a calendar view from the calendar template selection list 418 will result in a calendar view 108 being displayed. The calendar view 108 may also be printed within a culture specific context.

The method 600 may further include receiving user input defining a date or range of dates. In this case displaying a calendar view in a culture specific fashion further includes displaying time/or or date information for specific events falling on the date or range of dates.

Although the functional steps and non-functional acts may be described or claimed in a particular order, the present invention is not necessarily limited to any particular ordering or combination of acts and/or steps.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of their claims are to be embraced within their scope.

What is claimed is:

1. In a computing environment, a method of displaying a calendar, the method comprising:
obtaining a culture neutral calendar layout template from among a plurality of calendar layout templates as one or more data structures on a computer readable medium;
referencing culture context information;
selecting culture information stored as one or more data structures on a computer readable medium based on the culture context; and
merging the culture neutral calendar layout template with the culture information to create a culture specific calendar view.

2. The method of claim 1, wherein creating a culture specific calendar view comprises replacing strings with text in a culturally specific language.

3. The method of claim 1, wherein creating a culture specific calendar view comprises displaying content with a culturally specific date format.

4. The method of claim 1, wherein creating a culture specific calendar view comprises displaying content in a culturally specific orientation.

5. The method of claim 1, wherein creating a culture specific calendar view comprises displaying content within a view size specified for a particular culture.

6. The method of claim 1, wherein referencing culture context information comprises referencing a user created file.

7. The method of claim 1, wherein referencing culture context information comprises referencing system settings of a computer system.

8. The method of claim 1, wherein obtaining a culture neutral calendar layout template comprises downloading a calendar template.

9. The method of claim 1, further comprising merging event information with the culture neutral calendar information such that the culture specific calendar view includes a representation of scheduled events.

10. One or more computer readable media comprising:
a first data structure, the first data structure including information defining a culture neutral calendar layout selected from among a plurality of calendar layout templates;
a second data structure including culture information;
a third data structure, the third data structure including culture context information corresponding to the culture information and;
computer executable instructions configured to merge the culture neutral calendar layout template with the culture information based on a reference to the culture context information to create a culture specific calendar view.

11. The one or more computer readable media of claim 10, further comprising a fourth data structure including event information and wherein the computer executable instructions are further configured to merge the event information with the culture neutral calendar layout template to display event information in a format defined by the culture neutral calendar layout template.

12. The one or more computer readable media of claim 10, wherein the second data structure including culture information comprises a dll.

13. The one or more computer readable media of claim 12, wherein the dll includes a closed vocabulary corresponding to expected string content.

14. The one or more computer readable media of claim 10 wherein the third data structure including culture context information comprises a registry entry with information created as the result of a user setting system settings in a computer system.

15. The one or more computer readable media of claim 10 wherein the third data structure including culture context information comprises a user created file.

16. The one or more computer readable media of claim 10 wherein the first data structure including information defining a culture neutral calendar layout comprises a mark-up language document.

17. In a computer system having a graphical user interface including a display and a user interface selection device, a method of presenting calendar views including culture information merged with a culture neutral calendar template, the method comprising:
displaying a selection of views representing selectable culture neutral calendar layout templates;
receiving user input selecting one of the selectable culture neutral calendar layout templates;
receiving input defining a culture context;
receiving culture information defining culture specific details; and
displaying a calendar view in a culture specific fashion defined by culture information corresponding to the culture context merged with the one of the selectable culture neutral calendar layout templates selected by the received user input.

18. The method of claim 17, wherein displaying a selection of views representing selectable culture neutral calendar layout templates comprises displaying calendar views.

19. The method of claim 17, further comprising receiving user input defining a date or range of dates and wherein displaying a calendar view in a culture specific fashion further comprises displaying time/or or date information for specific events falling on the date or range of dates.

20. The method of claim 17, wherein receiving input defining a culture context comprises receiving user input as a result of the user interacting with the graphical user interface.
